(19) United States
(12) Patent Application Publication
(10) Pub. No.: US 2016/0047459 A1
(43) Pub. Date: Feb. 18, 2016

(54) Temperature-regulating Valve of Transmission Oil Cooling System in A Passenger Car

(71) Applicant: AIR INTERNATIONAL THERMAL SYSTEMS R & D (SHANGHAI) CO., LTD, Shanghai (CN)

(72) Inventor: Yuanman Wen, Shanghai (CN)

(73) Assignee: AIR INTERNATIONAL THERMAL SYSTEMS R & D (SHANGHAI) CO., LTD, Shanghai (CN)

(21) Appl. No.: 14/929,134

(22) Filed: Oct. 30, 2015

(51) Int. Cl. F16H 57/04; F16K 31/00; F16K 3/02

(52) U.S. Cl. CPC F16H 57/0413; F16K 3/0254; F16K 3/029; F16K 31/002

(57) ABSTRACT

A temperature-regulating valve comprises a valve body, two circlips, two small O-rings and a valve core, wherein the valve core is located in the chamber of the valve body and comprises a big retainer ring, an end cap, medium retainer ring, a big O-ring, a restraint block, a thermal component, a compression spring, small retainer ring, a slide block, a return spring and a release pressure plate.

### TECHNICAL FIELD

The present invention relates to a temperature-regulating valve, and more particularly, to a device for adjusting of temperature of transmission oil of a vehicle.

### BACKGROUND ART

The transmission oil in automatic gearbox in current passenger car takes the role of power transmission besides lubrication. The temperature of transmission oil must be kept within a certain range in order to ensure the normal operation. If the temperature of transmission oil is too high, the transmission oil will be high-temperature oxidized, the viscosity of the transmission oil reduces and the lubrication effect of the transmission oil goes bad, all of which will shorten the life of the gearbox. While if the temperature of transmission oil is too low, the viscosity of transmission oil increase with a bad fluidity which have a bad effect on lubrication and transmission.

There are four states in present invention: 1) when the temperature of transmission oil is below 67° C., the transmission oil directly passes through the bypass passage in the chamber of the temperature-regulating valve back into the gearbox while not passing through the oil cooler; 2) when the temperature of transmission oil is between 67° C. and 85° C., the transmission oil is divided into two parts: one directly passes through the bypass passage in the chamber of the temperature-regulating valve back into the gearbox, the other gets back into the gearbox after passing through the oil cooler; 3) when the temperature of transmission oil is equal to or high than 85° C., the transmission oil does not pass through the bypass passage in the chamber of the temperature-regulating valve, but gets back into the gearbox after passing through the oil cooler; 4) when the temperature of transmission oil is 121° C. and the oil pressure reaches 2.0˜2.5 bar, the bypass passage in the chamber of the temperature-regulating valve is opened, so a small part of the transmission oil pass through the bypass passage of temperature-regulating valve back into the chamber of the gearbox which releases the pressure of transmission oil cooling system and protects all parts of the transmission oil cooling system.

### SUMMARY OF THE INVENTION

### Technical Problem

As auto industry develops, auto company has changed release pressure requirement for the temperature-regulating valve in transmission oil cooling system: when the temperature of transmission oil is 121° C., the oil pressure reduces from 4.1˜5.5 bar to 2.0˜2.5 bar. As the valve core of temperature-regulating valve is constrained by space and structure, the pressure after being released by temperature-regulating valve cannot decrease to 2.0 bar˜2.5 bar for now in the worldwide.

### Solving the Technical Problem

When the temperature of transmission oil is 121° C., the release pressure of the temperature-regulating valve in transmission oil cooling system is 2.0˜2.5 bar when the bypass passage in the chamber of the temperature-regulating valve is opened, the pressure of transmission oil cooling system is released to protect all parts of the transmission oil cooling system. Only the valve body needs machining in all the parts of the temperature-regulating valve. As both the quick connector and the valve body are integrated structure and other parts are standard parts, plastic parts or rubber parts, all parts are not only easier to produce but also cheaper than existing products.

In order to solve the disadvantage of the existing technology, the present invention increases the cross-sectional area of the chamber in temperature-regulating valve, so as to increase the area of release pressure plate that transmission oil applies pressure on. When the oil temperature reaches 121° C. and the pressure of transmission oil reaches 2.0 bar˜2.5 bar, thrust that transmission oil applies on release pressure plate is greater than the compression force of the return spring which promotes the release pressure plate to move. So that a part of the transmission oil gets through the bypass passage of temperature-regulating valve back into the gearbox to release the pressure and to protect the transmission oil cooling system.

The present invention of temperature-regulating valve includes a valve core, the quick connector and the valve body are integrated structure. Valve body is made of extruded profiles of aluminum alloy that weight is light. There are three valve ports in valve chamber: the first valve port, the second valve port and the third valve port. The chamber connects with the cavity in one side of the valve body and the cavity is sealed by O ring installed on end cap which is fixed by retainer ring in the hole. Valve core is installed in the valve chamber and the most critical part in valve core is the thermal component in which the heat sensitive material is filled. The lengthening or shortening of pushrod of thermal component is controlled by the expansion and contraction of heat sensitive material. The outside end of the pushrod of the thermal component contacts with end cap and the other end is connected with slide block through compression spring. Slide block, release pressure plate and return spring are fixed between the first valve port and the second valve port by retainer ring. Thermal component lies between restraint block and the first valve port, while the restraint block lies between the second valve port and the third valve port.

There is a third flow channel in the valve body which connects with the third valve port. And the central axis of the third flow channel is mutually perpendicular with that of the third valve port.

The first flow channel includes the first valve port, the bore of the release pressure plate, the bore of the slide block and the second valve port. The second flow channel includes the second valve port and the orifice of restraint block and the third valve port.

When the temperature of transmission oil is lower than 67° C., thermal sensitive material in thermal component doesn't expand. Thermal component is pushed by the compression spring so that the orifice of restraint block is sealed and the second flow channel is blocked while the first flow channel is open. And transmission oil gets back to gearbox through the first flow channel without passing through the oil cooler, so transmission oil heats up fast in relatively short time to achieve optimum oil temperature.

When the temperature of transmission oil is between 67° C. and 85° C., thermal sensitive material in thermal component starts to expand. As the outside end of the pushrod of the thermal component contacts with the end cap, the pushrod is fixed and the thermal component has to move towards the first valve port so that both the first and the second flow channel are open. And the transmission oil is divided into two parts: One directly pass through the first flow channel back into the gearbox, the other gets into the oil cooler through the third flow channel, and then gets back into the gearbox through the second flow channel after being cooled in the oil cooler.

When the temperature of transmission oil is equal to or higher than 85° C., thermal sensitive material in thermal component continues to expand. The bore of slide block is sealed by the end face of the body of thermal component so that the first flow channel is blocked and the second flow channel is open. And the transmission oil gets into the oil cooler through the third flow channel, and then gets back into the gearbox through the second flow channel after being cooled in the oil cooler.

When the gearbox stops working, the temperature of the transmission oil begin to drop and the thermal component moves towards the inner side of the valve as the thermal component is pushed by the compressing force of both the compression spring and the return spring until the body of the thermal component sealed the orifice of the restraint block and temperature-regulating valve restores the initial state while the temperature of the transmission oil is lower than 67° C.

### BRIEF DESCRIPTION OF THE DRAWINGS

FIG. 1 is the ISO view of the present temperature-regulating valve.

FIG. 2 is the front view of the present temperature-regulating valve.

FIG. 3 is the section view of the present temperature-regulating valve cut from direction A-A shown as FIG. 2 with the second flow channel blocked when the temperature of the transmission oil is lower than 67° C.

FIG. 4 is the section view of the present temperature-regulating valve cut from direction A-A shown as FIG. 2 with both the first and the second flow channel open when the temperature of the transmission oil is below between 67° C. and 85° C.

FIG. 5 is the section view of the present temperature-regulating valve cut from direction A-A shown as FIG. 2 with the first flow channel blocked when the temperature of the transmission oil is higher than 85° C.

FIG. 6 is the section view of the present temperature-regulating valve cut from direction A-A shown as FIG. 2 with the first flow channel blocked as the slide block keeps moving pushed by the thermal component when the temperature of the transmission oil is higher than 85° C.

FIG. 7 is the section view of the present temperature-regulating valve cut from direction A-A shown as FIG. 2 with the release pressure plate pushed left when the temperature of the transmission oil is 121° C. and the oil pressure reaches 2.0˜2.5 bar.

FIG. 8 is the ISO view of thermal component.

FIG. 9 is the ISO view of restraint block.

FIG. 10 is the ISO view of slide block.

FIG. 11 is the ISO view of release pressure plate.

### REPRESENTATIONS OF REFERENCE NUMBERS IN THE DRAWINGS

1: big retainer ring; 2: end cap; 3: medium retainer ring; 4: valve body; 5: big O-ring; 6: the third valve port; 7: restraint block (orifice 24, end face 25); 8: thermal component (pushrod 22, body 23, end face 19, end face 20, end face 21); 9: compression spring; 10: small retainer ring; 11: slide block (shaft 26, end face 27, slot 28, bore 29); 12: return spring; 13: release pressure plate (end face 31, bore 30, release pressure slot 32); 14: the first valve port; 15: the third flow channel; 16: circlip; 17: the second valve port; 18: small O-ring.

### DETAILED DESCRIPTION OF EMBODIMENTS OF THE INVENTION

Give The Present Invention Patent Further Description referring to The Drawings:

The directions (top, bottom, left and right, etc.) are in accordance with the directions in drawings;

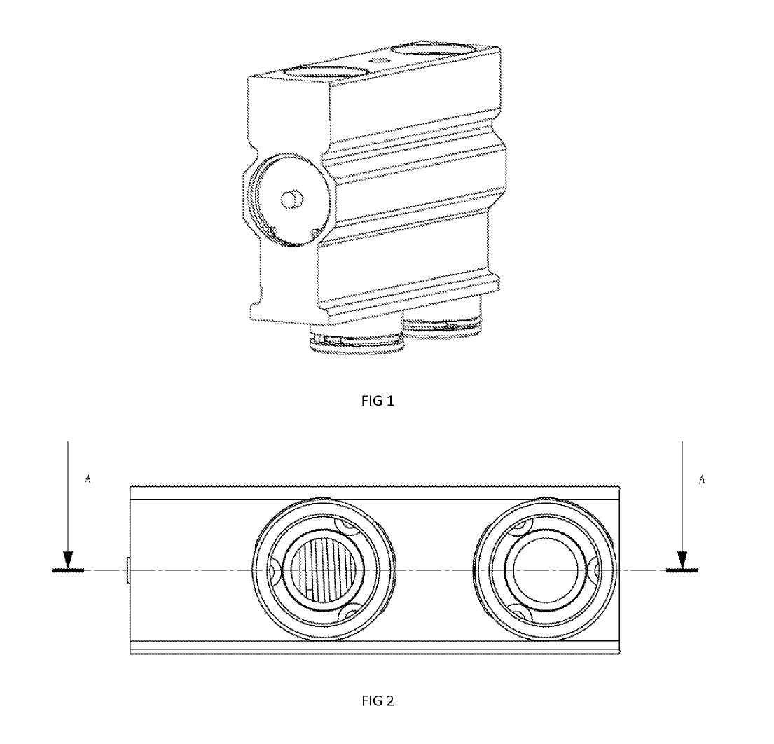

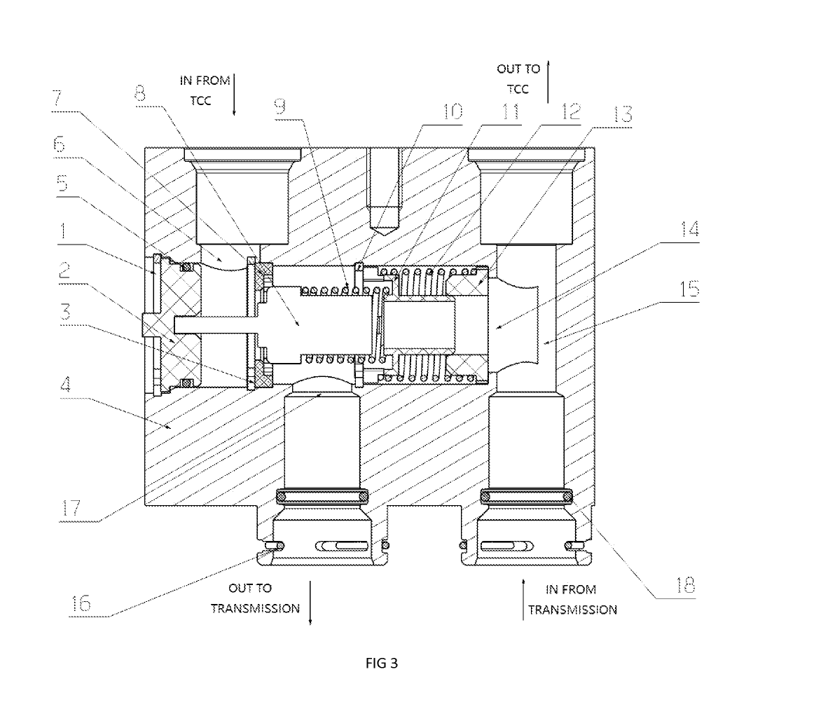

As illustrated in FIG. 1 and FIG. 3, in the transmission oil cooling temperature-regulating valve of passenger car, there are four ports of which the upper two connect with the oil cooler and the lower two connect with the gearbox. The temperature-regulating valve includes a valve body 4, two circlips 16, two small O-rings 18 and a valve core. The valve core is located in the chamber of the valve body 4 and the valve core includes a big retainer ring, an end cap 2, a medium retainer ring 3, a big O-ring 5, a restraint block 7, a thermal component 8, a compression spring 9, a small retainer ring 10, a slide block 11, a return spring 12 and a release pressure plate 13. There is a groove in the end cap 2 along the circumferential direction. The big O-ring 5 is installed in the groove. The end cap 2 fixed on the left side of the valve body 4 by big retainer ring 1 plays a role of sealing the open end of the valve body 4. The restraint block 7 is fixed between the second valve port and the third valve port by the medium retainer ring 3. The slide block 11, return spring 12 and release pressure plate 13 are fixed between the second valve port and the first valve port by small retainer ring 10 when the depth of the shaft 26 of the slide block 11 inserted in the bore 30 of the release pressure plate 13 is 1.5 mm, The initial spring force of the compression spring 9 pushes the pushrod 22 of thermal component 8 until both the top of the pushrod 22 contacts with the end cap 2. The end face 21 of the thermal component 8 contacts with the end face 25 of the restraint block 7 when the orifice 24 of restraint block 7 is completely blocked. The distance between the end face 27 of the slide block 11 and the end face 19 of the thermal component 8 is 3.5 mm.

The first flow channel is composed by the first valve port 14, the bore 30 of the release pressure plate 13, the bore 29 of the slide block and the second valve port. The second flow channel is composed by the second valve port 17 and the orifice 24 of restraint block 7 and the third valve port 6.

As illustrated in FIG. 3, when the temperature of transmission oil is lower than 67° C., thermal sensitive material in thermal component 8 does not expand and the pushrod 22 of the thermal component 8 doesn't move. As the second flow channel is blocked completely. Transmission oil gets back to gearbox through the first flow channel without passing through the oil cooler.

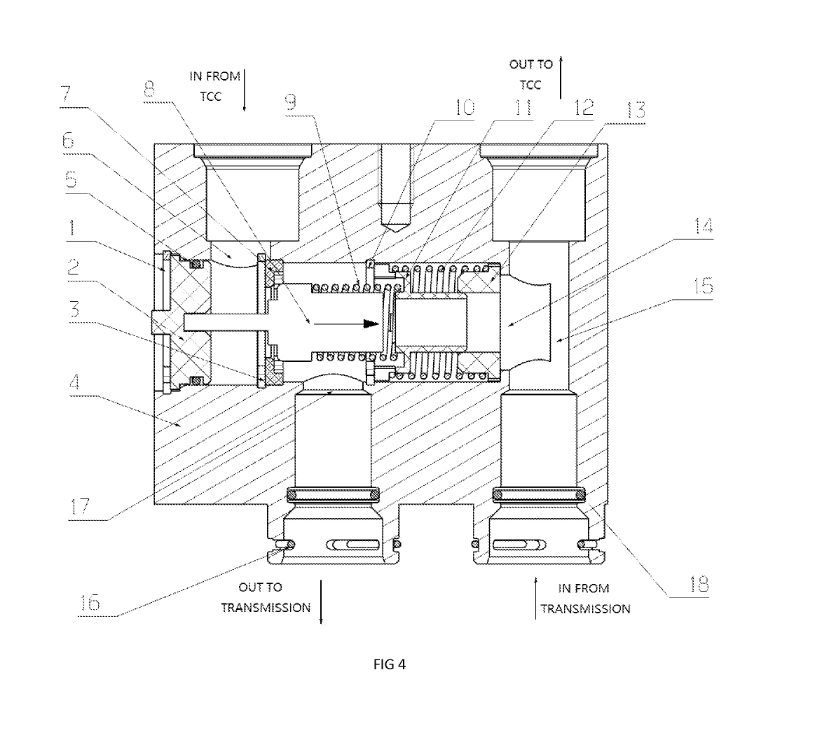

As illustrated in FIG. 4, When the temperature of transmission oil is between 67° C. and 85° C., thermal sensitive material in thermal component 8 starts to expand to push the pushrod 22 towards the outside of the body 23 of thermal component 8. As the outside end of the pushrod 22 is connected with the end cap, the body of thermal component 8 can't move left but right only to compress the compression spring 9 when both the first and the second flow channel are open. And the transmission oil is divided into two parts: One directly crosses the first flow channel back into the gearbox, gets into the oil cooler through the third flow channel, and then gets back into the gearbox through the second flow channel after being cooled in the oil cooler.

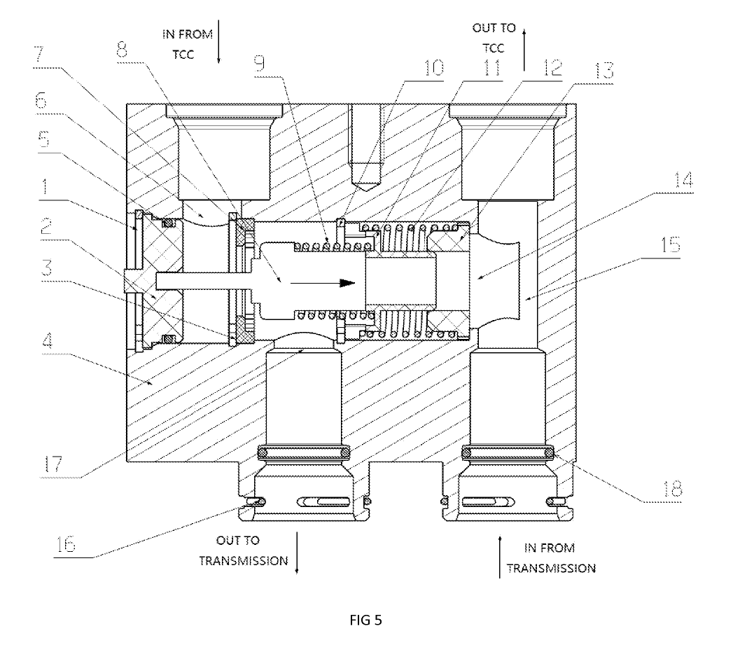

As illustrated in FIG. 5, when the temperature of transmission oil reaches 85° C., the initial spring force of the return spring 12 is required to be greater than the compressive force that thermal component 8 applies on the compression spring 9, so that the slide block 11 does not move. The distance that the body 23 of the thermal component 8 moves right is required to be 3.5 mm. As the end face 19 of the thermal component 8 contacts with the end face 27 of the slide block 11, the first flow channel is blocked and the transmission oil gets into the oil cooler through the third flow channel, and then gets back into the gearbox through the second flow channel after being cooled in the oil cooler.

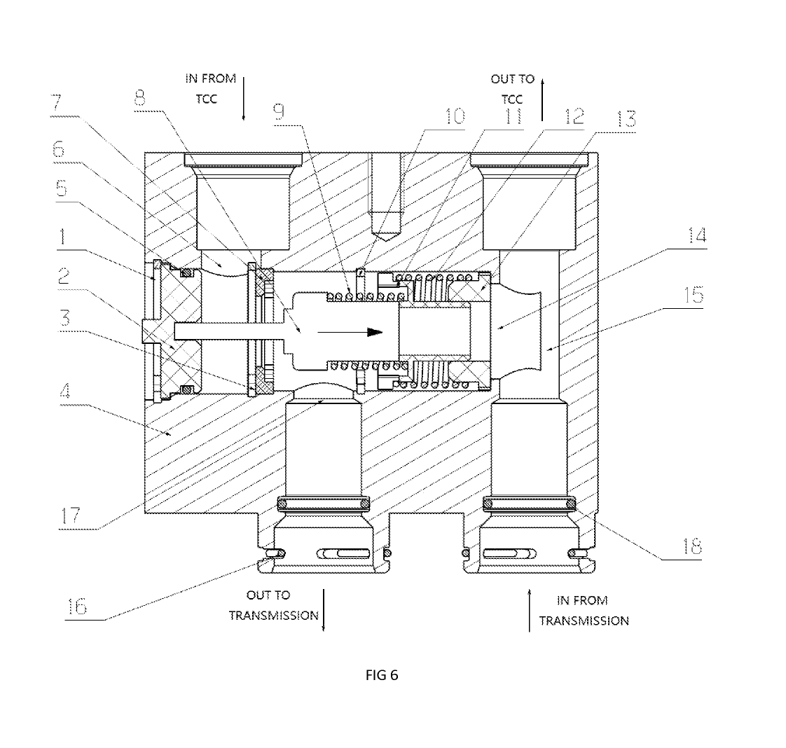

As illustrated in FIG. 6, when the temperature of transmission oil is higher than 85° C., thermal sensitive material in thermal component 8 continues to expand, so the slide block 11 is pushed by the body 23 of the thermal component 8 to compress return spring 12 to move right. When the temperature of transmission oil reaches 160° C., the design requires the distance that the body 23 of the thermal component 8 moves right is less than 10.5 mm.

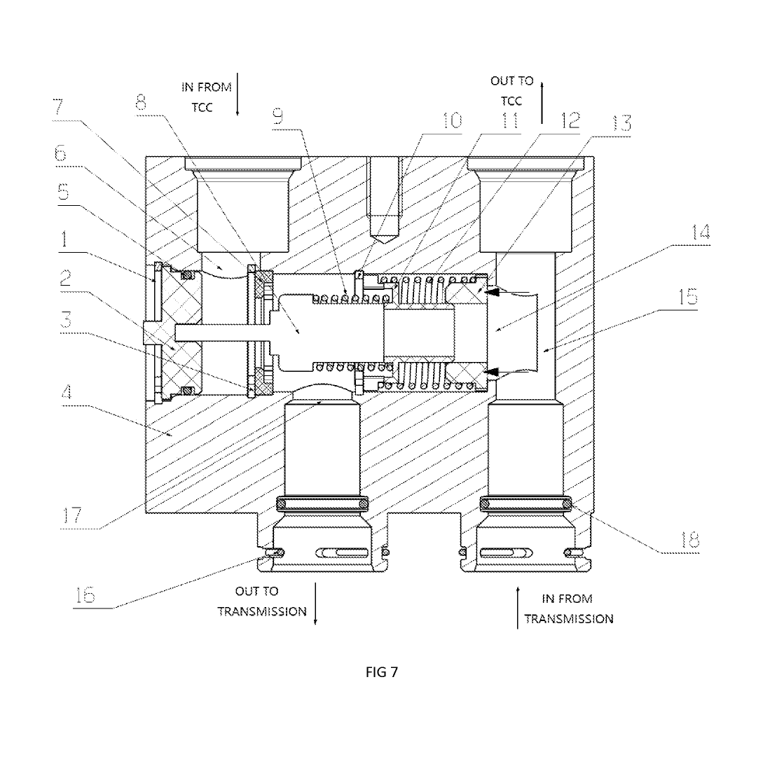

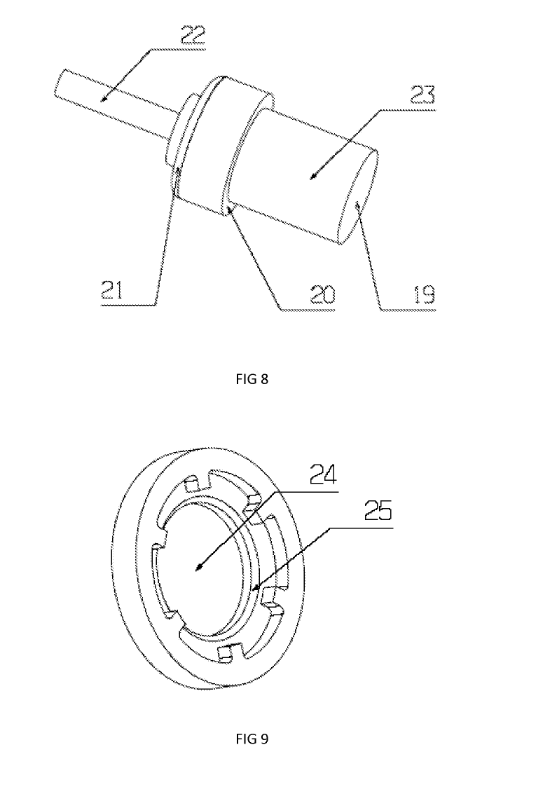

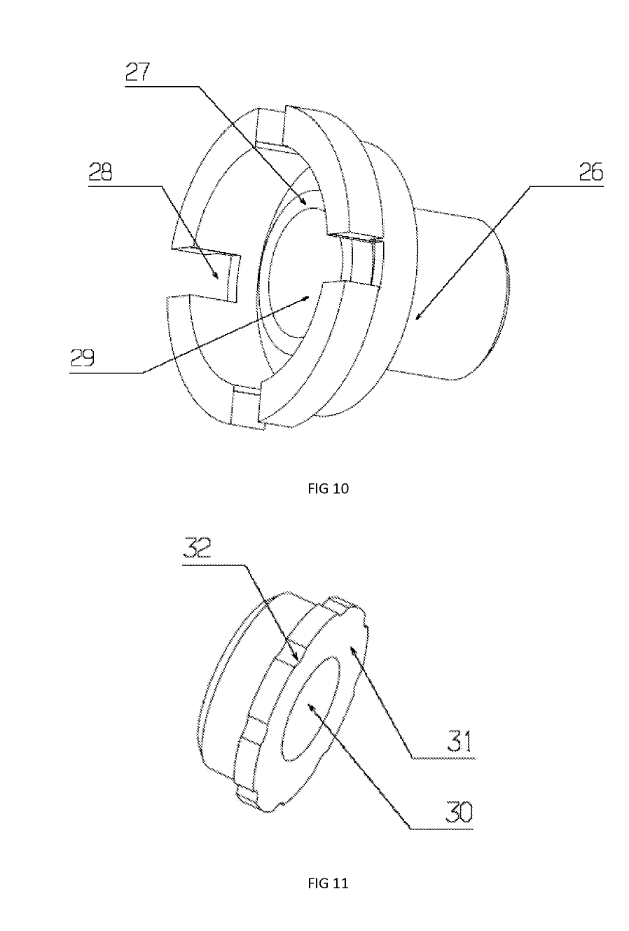

As illustrated in FIG. 7, when the temperature of the transmission oil is 121° C. and the oil pressure reaches 2.0˜2.5 bar, the thrust on end face 30 of release pressure plate 13 is larger than the compressive force of the return spring 12 which is compressed to push release pressure plate 13 to the left. So a part of the transmission can get through the release groove 32 of the release pressure plate 13 back into the gearbox to release the pressure of the transmission oil cooling system. The area that transmission oil applies force on release pressure plate 13, S=the cross-sectional area of the first valve port 14−the cross-sectional area of the bore 30 sectional area of the release pressure plate 13. And the thrust that transmission oil applies on release plate 13, F=S*(2.0·2.5), F is greater than the compressive force of the return spring 12. As the S of the present invention is 20% to 50% larger than the temperature-regulating valve all over the world, so the release pressure plate 13 can also be pushed to the left to release pressure even when the pressure of transmission oil is reduced by 20 to 50% to 2.0˜2.5 Bar.

When the gearbox is stopped, the temperature of the transmission oil begin to drop and the thermal sensitive material in the thermal component 8 begin to shrink and the body 23 of thermal component 8 is pushed to the left under the spring force of both the compression spring 9 and return spring 12, and the pushrod 22 is pushed towards the body 23 of thermal component 8. Temperature-regulating valve restores the initial state as shown in FIG. 3 while the temperature of the transmission oil decreases to lower than 67° C.

What is claimed is:

1. A temperature-regulating valve comprises a valve body integrated with two quick connectors, two circlips, two small O-rings and a valve core; wherein
the valve core is located in the chamber of the valve body and comprises a big retainer ring, an end cap, medium retainer ring, a big O-ring, a restraint block, a thermal component, a compression spring, a small retainer ring, a slide block, a return spring and a release pressure plate; wherein the end cap, which has a groove installed by the big O-ring, is fixed on the left side of the valve body by a big retainer ring which is used for sealing the open end of the valve body; the restraint block is fixed between a second valve port and a third valve port by the medium retainer ring; the slide block, the return spring and the release pressure plate are fixed between the second valve port and a first valve port by the small retainer ring wherein a shaft of the slide block inserted in a bore of the release pressure plate.

2. The temperature-regulating valve according to claim 1, wherein the initial spring force of the compression spring pushes the pushrod of a thermal component until both the top of the pushrod contacts with the end cap; the end face of the thermal component contacts with the end face of the restraint block when the orifice of the restraint block is completely blocked.

3. The temperature-regulating valve according to claim 1, wherein a first flow channel comprises the first valve port, the bore of the release pressure plate 1 the bore of the slide block and the second valve port.

4. The temperature-regulating valve according to claim 3, wherein a second flow channel comprises the second valve port and the orifice of the restraint block and the third valve port.

5. The temperature-regulating valve according to claim 4, wherein the thermal sensitive material in the thermal component does not expand and the pushrod of the thermal component doesn't move when the temperature of transmission oil is below 67° C., while the second flow channel is blocked and the transmission oil is back to gearbox through the first flow channel without passing through an oil cooler.

6. The temperature-regulating valve according to claim 5, wherein the thermal sensitive material in the thermal component expands to push the pushrod towards the outside of the body of thermal component, the outside end of the pushrod is connected with the end cap, the body of the thermal component move right to compress the compression spring when both the first and the second flow channels are open when the temperature of transmission oil is between 67° C. and 85° C., while the transmission oil flows through the first flow channel back into the gearbox, through the oil cooler, through the third flow channel, and then flows back into the gearbox through the second flow channel after being cooled in the oil cooler.

7. The temperature-regulating valve according to claim 6, wherein the initial spring force of the return spring is greater than the compressive force when the thermal component applies on the compression spring which prevents the movement of the slide block, the end face of the thermal component contacts with the end face of the slide block when the temperature of transmission oil reaches 85° C., while the first flow channel is blocked and the transmission oil flows into the oil cooler through the third flow channel, and then flows back into the gearbox through the second flow channel after being cooled in the oil cooler.

8. The temperature-regulating valve according to claim 7, wherein the thermal sensitive material of the thermal component continues to expand that pushes the slide block to compress the return spring to the right when the temperature of transmission oil is higher than 85° C.

9. The temperature-regulating valve according to claim 8, wherein the thrust on end face of the release pressure plate is greater than the compressive force of the return spring which pushes the release pressure plate the left when the temperature of the transmission oil is 121° C. and the oil pressure reaches 2.0˜2.5 bar; while a part of the transmission flows through the release groove of the release pressure plate into the gearbox that releases a pressure of a transmission oil cooling system.
